(19) United States
(12) Patent Application Publication
(10) Pub. No.: US 2016/0055264 A1
(43) Pub. Date: Feb. 25, 2016

(54) ORGAN CONSTRUCT AND METHODS OF MANUFACTURE THEREOF

(71) Applicant: UNIVERSITY OF FLORIDA RESEARCH FOUNDATION, INC., Gainesville, FL (US)

(72) Inventors: DAVID L. MEADOWS, Colleyville, TX (US); DANIEL JOHN DICKRELL, III, GAINESVILLE, FL (US); RICHARD D. CLARK, III, AUSTIN, TX (US)

(21) Appl. No.: 14/783,099

(22) PCT Filed: Apr. 11, 2014
(86) PCT No.: PCT/US14/33801

§ 371 Date: Oct. 8, 2015

Related U.S. Application Data
(60) Provisional application No. 61/810,928, filed on Apr. 11, 2013.

(51) Int. Cl. G06F 17/50; G06F 17/10

(52) U.S. Cl. CPC G06F 17/50; G06F 17/10

(57) ABSTRACT

Disclosed herein is a method for designing an organ for use in a body of a living being comprising identifying a fluid transport demand of an organ; where the fluid transport demand is the amount of fluid used by the organ to sustain itself and to sustain utility in other organs around it; and where the organ comprises a flow system comprising a network of vessels; determining a spatial density of zones of need in the organ based on a density of normal healthy tissues in the organ; identifying a nature of the flow system; and using constructal principle analysis to generate a design of the organ. Disclosed herein too is an organ manufactured by the aforementioned method.

### CROSS REFERENCE TO RELATED APPLICATIONS

This application claims priority to International Application No. PCT/US14/033801 filed on Apr. 11, 2014, which claims the benefit of U.S. Application No. 61/810,928, filed on Apr. 11, 2013, both applications are incorporated herein by reference in their entirety.

### BACKGROUND

This disclosure relates to an organ construct and to methods of manufacture thereof.

Living beings are composed of a number of organs. Some of these organs fail over time due to disease, old age, and the like. It is desirable to replace these organs when they fail. Replacement organs are often not easy to obtain. For example, there is a large waiting list for replacement livers and kidneys. Living beings that desire replacements often pass away before a proper matching donor with the appropriate blood type is found.

It is therefore desirable to artificially synthesize organs that can behave much in the same manner as naturally occurring organs.

### SUMMARY

Disclosed herein is a method for designing an organ for use in a body of a living being comprising identifying a fluid transport demand of an organ; where the fluid transport demand is the amount of fluid used by the organ to sustain itself and to sustain utility in other organs around it; and where the organ comprises a flow system comprising a network of vessels; determining a spatial density of zones of need in the organ based on a density of normal healthy tissues in the organ; identifying a nature of the flow system; and using constructal principle analysis to generate a design of the organ.

Disclosed herein too is an organ manufactured by the aforementioned method.

### BRIEF DESCRIPTION OF THE FIGURES

FIG. 1 is an artificial organ construct with identified points of biological need shown;

FIG. 2 is a depiction of an optimal network structure formed by connecting the source and sink locations;

FIG. 3 is a layout for the artificial biological network that is transmitted to the synthesizing platform for incorporation into the artificial organ under production;

FIG. 4 depicts the original fundus image (top-left) was used along with its segmentation (top right) to define the arterial network (bottom left) and the venous network (bottom right);

FIG. 5 depicts a method of creating the arterial network. In order to create the arterial network (bottom left), the original fundus (top left) was inspected and the venous segments were removed from the segmented image (top right). In order to create the venous network (bottom right), the arterial segments were removed;

FIG. 6 depicts how endpoints (top) were defined as points of observable termination while the bifurcations (bottom) were defined as points at which the network divides into two child segments;

FIG. 7 depicts the thinned network (red) was overlaid on the green layer of the original fundus image. The user then selected an origin point that defined the node of the central retinal artery or the central retinal vein;

FIG. 8 depicts that after being thinned, the network was defined in terms of segments, or lengths of pixels between bifurcations, or nodes, consisting of endpoints, bifurcation points, and the origin node;

FIG. 9 is a depiction of the width of the vessel that was first estimated by determining the distance from the thinned network to the nearest non-vessel pixel in the segmented image. Pixels that are more red define greater distances from non-vessel pixels;

FIG. 10 shows that for each thinned pixel, a number of connected thinned pixels equal to 3/2 the estimated width was examined on either side;

FIG. 11 depicts that the resistance of a segment was defined by its geometry alone. The diameter defined the viscosity of the blood flowing through the segment, which was then used with the length and diameter to calculate the fluid resistance of the segment;

FIG. 12 shows that when an endpoint is encountered, a series of bifurcations exhibiting a predetermined geometric nature was appended to connect the segment to the capillary bed;

FIG. 13A shows that the fluid resistance for arteries and veins along a line displaying the means are shown for networks without the virtual networks attached; and

FIG. 13B shows that the fluid resistance for arteries and veins along a line displaying the means are shown for networks with the virtual networks attached.

### DETAILED DESCRIPTION

Disclosed herein is a design for an organ construct that is derived from a non-equilibrium thermodynamic optimization of flow systems in an existing organ. The non-equilibrium thermodynamic optimization (of the flow system) is based on constructal theory and analysis and includes understanding and determining the initial conditions, boundary conditions and operating constraints for optimizing the flow in an apparently random pathway, pattern or network that transports fluid in an organ whose construct is eventually desired. The design involves determining optimal vessel diameters, vessel connection angles, vessel nodes and junction, and the like, based on needs (metabolic, waste removal, neurological, structural, and the like) of the organ by considering factors such as the “efficiency of the system” “boundary conditions”, “energy minimization”, “guiding forces”, “design constraints”, “minimization of losses”, or the like. The design eventually provides a blue-print for developing an organ (hereinafter termed an “organ construct”) that can be used either inside the body or outside the body of a living being. The organ construct can partially or completely replace an existing organ and can fully or partially perform all functions desired of the organ.

The organ construct can be for an organ or body part such as the liver, pancreas, heart, kidney, cornea, brain, spinal cord, aorta, bone, collagen, nervous system, and the like.

Disclosed herein too is an organ construct that is derived from a design based on constructal analysis. The organ construct can be synthesized from artificial or natural materials that are biocompatible or that are coated with biocompatible materials. The organ construct can be synthesized with cellular materials (e.g., epithelial cells). The organ construct can also be synthesized with biodegradable materials. The constructal analysis permits one to synthesize either a partial or a complete organ and to use it in the body of a living being in lieu of a replacement organ that is derived from the body of another living being. This is advantageous because it eliminates delays in waiting for a substitute organ. It can save lives, reduces the risk of donor rejection and improve the quality of life for a patient that has a malfunctioning organ.

Disclosed herein too is a method of manufacturing a synthetic organ using constructal analysis. The method comprises synthesizing a biological network for use in artificial organ construction by using constructal principles. The method comprises identifying the transport needs of the organ or structure that is to be synthesized. For example, in a synthetic construction of an artificial liver, it is prudent to ponder which flow systems are desirable for proper organ function. A determination of the spatial distribution of “zones of need” based on the density of normal healthy tissues within the organ related to the flow system being synthesized is conducted. The nature of the flow system is then identified. For example, is the flow, a point source-to-area system (a river delta) or is it an area-to-point system (a watershed), or a hybrid mixture (wetlands). This establishes morphological boundary conditions for the flow system. Non-equilibrium thermodynamic optimization principles (constructal principles) are then used to connect the boundary condition locations with a transport network. The constructal principle optimization of the network yields branch point locations, branch angles, and parent-child diameter ratios for a most-optimally designed flow system. A design layout is then generated for an optimized flow system for use in the synthesizing method.

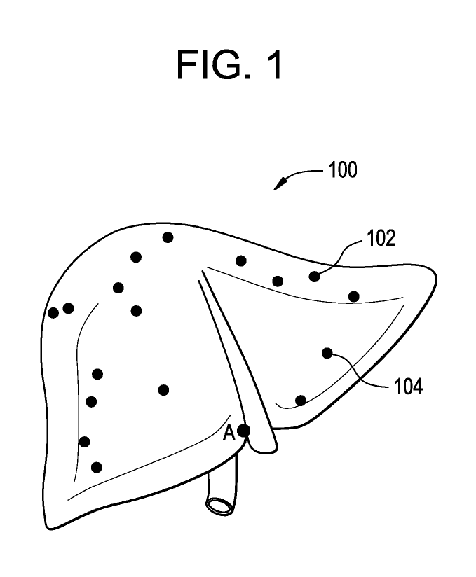

The FIG. 1 depicts an organ 100, a construct of which is desired. The organ 100 comprises a point indicated by the letter “A” (referred to hereinafter as point A). The point A is a “source” point to which fluid (e.g., blood, air, lymph) or energy (e.g., neurological pulses) are transmitted from outside the organ. The fluid is transmitted from the source point A to a plurality of “other points” in the organ. These “other points” are shown by black spots in the FIG. 1. These points can lie at any points in the organ. A couple of these points are depicted I the FIG. 1 using reference numerals 102 and 104. The other points 102, 104, and the like, are termed “sink” points, since they receive fluid from the source point A. The identification of the source point A and the sink point facilitates a determination of the design of the flow system within the organ. It also facilitates a determination of the zones of need within the organ.

Constructal analysis is then applied to determine the shape and size of the vessels that connect the source point A and the sink points 102, 104, and the like. Constructal analysis uses non-equilibrium thermodynamic optimization principles and takes into account features of the organ such as the end to end distance of a vascular network present in the organ, the radius of gyration of the vascular network, junction angles of branches of the vascular network, vessel widths/diameters, vessel lengths, vessel tortuosities, junction exponents, asymmetry ratios, area ratios, parent-child angle changes, parent-child vessel diameter ratios-child-child diameter ratios, overall links/volume of observable vasculature, metrics as a function of vessel generations, metrics as a function of location, and the like, to help determine optimal pathways of a vascular network that is disposed in the organ.

For example, the flows between the source point A and the sink points 102, 104, respectively in the FIG. 1 can be assumed to be a steady, laminar flow of a Newtonian fluid. This assumption will lead to one set of design parameters for the organ construct. On the other hand, the flow can be assumed to be that of a non-Newtonian fluid, which will yield to another set of design parameters for the organ construct. By varying assumptions, a design can be arrived at that closely mimics the function of the actual vessels in an actual living organ. The design can then be used in the construction of an actual organ that can be used as a substitute organ in the body of a living being.

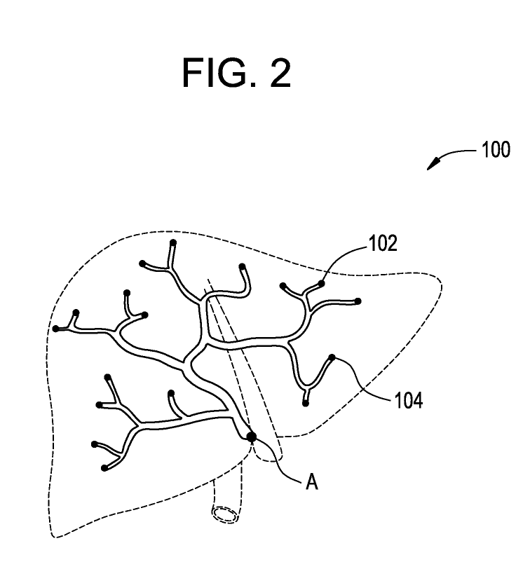

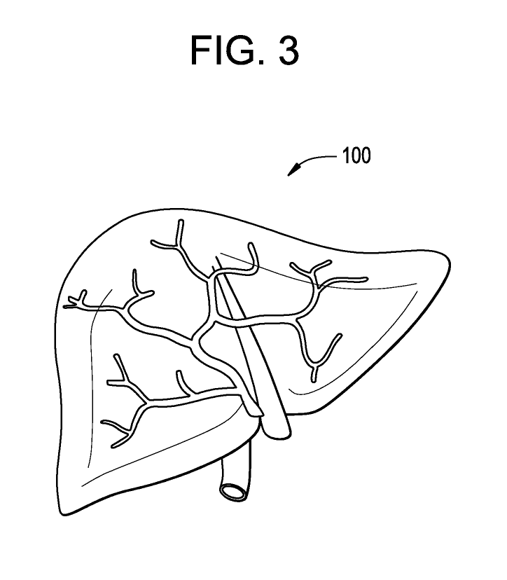

The FIG. 2 depicts one network structure that is formed by connecting the source and sink locations. The branching locations, angles, and diameter ratios are iteratively varied in order to find the configuration that gives the most optimal network structure. The FIG. 3 depicts the layout for an artificial network that is transmitted to a synthesizing platform for incorporation into the artificial organ under production.

The constructal analysis and the resulting design can be performed on a computing device. This will be discussed in detail later.

The organ construct can be formed from a variety of organic polymers. Suitable organic polymers are thermoplastic polymers, thermosetting polymers, blends of thermoplastic polymers, blends of thermosetting polymers, and blends of thermoplastic polymers with thermosetting polymers. The organic polymer can be a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers. Biopolymers are preferred.

Biopolymers are polymers produced by living organisms. Since they are polymers, biopolymers contain monomeric units that are covalently bonded to form larger structures. Polynucleotides (RNA and DNA), which are long polymers composed of 13 or more nucleotide monomers; polypeptides, which are short polymers of amino acids; and polysaccharides, which are often linear bonded polymeric carbohydrate structures may be used to form the biopolymers.

Polymers that can be used for the organ construct also include biodegradable polymers. Suitable examples of biodegradable polymers are as polylactic-glycolic acid (PLGA), poly-caprolactone (PCL), copolymers of polylactic-glycolic acid and poly-caprolactone (PCL-PLGA copolymer), polyhydroxy-butyrate-valerate (PHBV), polyorthoester (POE), polyethylene oxide-butylene terephthalate (PEO-PBTP), poly-D,L-lactic acid-p-dioxanone-polyethylene glycol block copolymer (PLA-DX-PEG), or the like, or combinations comprising at least one of the foregoing biodegradable polymers. The biodegradable polymers upon undergoing degradation can be consumed by the body without any undesirable side effects.

As noted above, thermoplastic and thermosetting organic polymers may be used in the organ construct. Examples of thermoplastic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene propylene diene rubber (EPR), polytetrafluoroethylene, fluorinated ethylene propylene, perfluoroalkoxyethylene, polychlorotrifluoroethylene, polyvinylidene fluoride, polysiloxanes, or the like, or a combination comprising at least one of the foregoing organic polymers.

Examples of thermosetting polymers suitable for use in the organ construct include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

The organic polymers can be coated with biocompatible polymers such as fluoropolymers or polysiloxanes.

In one embodiment, in one method of manufacturing the organ construct, after the design is optimized using constructal analysis, a mold or a series of molds can be constructed that facilitate the manufacturing of the organ construct. The polymers can be cast into the mold from solution or alternatively they can be discharged into the mold in the form of a melt. The molded organ can then be preserved at the appropriate conditions and substituted for a functioning organ when desired. The molding can comprise injection molding, compression molding, blow molding, vacuum forming, or the like, or a combination comprising at least one of the foregoing.

Other manufacturing techniques such as spin coating, spin casting, spray painting, dip coating, or the like, can also be conducted to form the organ.

In another embodiment, the organ construct can be manufactured by 3D-printing, also known as rapid prototyping. The constructal analysis design along with calculations can be fed into a 3D-printer to form the organ construct from raw materials contained in the printer. The organ can then be preserved at the appropriate conditions and substituted for a functioning organ when desired.

As noted above, the constructal analysis calculations can be implemented as logic executed in one or more computing devices. A computing device according to the disclosure can include at least one processor and a memory, both of which are in electrical communication with a local interface. To this end, the computing device may comprise, for example, at least one server computer or like device. The local interface may comprise, for example, a data bus with an accompanying address/control bus or other bus structure as can be appreciated.

Stored in the memory are both data and several components that are executable by the processor. In particular, stored in the memory and executable by the processor is an application implementing logic according to constructal principles as well as potentially other applications. It is understood that there may be other applications that are stored in the memory and are executable by the processors. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory and are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor, source code that may be expressed in proper format such as object code that is capable of being loaded into a random access portion of the memory and executed by the processor, or source code that may be interpreted by another executable program to generate instructions in a random access portion of the memory to be executed by the processor, and the like. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor may represent multiple processors and the memory may represent multiple memories that operate in parallel processing circuits, respectively. In such a case, the local interface may be an appropriate network that facilitates communication between any two of the multiple processors, between any processor and any of the memories, or between any two of the memories, etc. The local interface may comprise additional systems designed to coordinate this communication, including, for example, performing load balancing. The processor may be of electrical or of some other available construction.

Although executable logic of an embodiment of the disclosure may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, and the like.

Also, any logic or application according to an embodiment of the disclosure that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The data can be stored on the cloud and can be made accessible to specialists across the world. This will permit remote access of images and testing of patients in remote regions across the world. Storage of data on the cloud can be used to compare behavior or morphology in normal populations versus diseased populations and to aggregate such statistics in mass populations.

The constructal analysis method can be detailed as follows. The processing of the image begins by obtaining a binary image of an isolated arterial or venous network. The image is a pixelated image with white pixels being equivalent to the vasculature and dark pixels representing the background. A determination is made of the total number of particles (discrete areas of white pixels) and other pixels (i.e. all particles) but the one comprising of the most pixels are removed. In other words, the imaged vasculature is smoothed out to a series of points that represent the highest pixel density along the path of the vasculature. A thinning algorithm is then used that reduces the network to paths with widths of one pixel. Any “spurs” or small lengths of network containing endpoints are then removed. The stub removal has an arbitrary threshold. It is cut off at around 5-10 pixels which is less that 5% of the overall segment length. A flow source (i.e., a series of interconnected arteries or veins through which flow occurs) in the image is then used for further study by manually selecting a suitable area in the image as follows.

Manually select the left and right edges of the optic disc to determine a pixel-to-micron ratio based on a diameter of 1.76 mm. Determine all endpoints and junctions in the network by analyzing each vascular pixel's connectivity to neighboring pixels. Define the network by “walking” along the vascular network from each junction. The following are determined:

Nodes—Junctions, Endpoints, or the Flow Source Area. Segments—Lengths of Pixels Connecting Nodes

The width of all segments in the vascular network in the optical disc are determined by performing a principal component analysis on the thinned segment, then taking N perpendicular measurements along the segment in the binary image and averaging the measurements. N is generally between 3 and 7. Determine the lengths of segments by accumulating and summing up pixel-to-pixel lengths from one end of a segment to the other. To pixels sharing a side of the segment add a length of 1.0 while for pixels sharing a corner of the segment, add a length of 1.41 multiplied by the length of the side of the pixel.

Determine the generation of each segment by attributing a generation number of “1” to each segment connected to the flow source. Each bifurcation thereafter adds a generational number to the child segments. For example, a child segment that branches of a main segment is given the number 1, while a 2^{nd} child segment that branches of the 1^{st} child segment is given the number 2, and so on. Determine the viscosity in each segment based on its diameter and an assumed hematocrit level. The haematocrit (Ht or HCT), also known as packed cell volume (PCV) or erythrocyte volume fraction (EVF), is the volume percentage (%) of red blood cells in blood. It is normally about 45% for men and 40% for women. It is considered an integral part of a person's complete blood count results, along with hemoglobin concentration, white blood cell count, and platelet count. Determine the fluid conductance in each segment using the Hagen-Poiseuille equation.

In short, as detailed above, after isolating a portion of a binarized vascular system (or an equivalent flow system such as a river, and the like), extraneous rough edges and small segment lengths are removed. Segment widths and lengths are calculated and each generational segment is assigned a numerical value depending upon its location from the main segment. The viscosity of fluids being transported through the segments is then computed. The flow in each segment and in the entire binarized vascular system is then determined using the Hagen-Poiseuille equation.

$$Δ P = \frac{8 μ LQ}{π {r}^{4}} \qquad ( 1 )$$

where ΔP is the pressure loss through the segment; L is the length of segment; μ is the dynamic viscosity; Q is the volumetric flow rate through the segment; and r is the radius of the segment.

For each segment endpoint, determine a virtual bifurcating network whose relative diameter is a function of Murray's Law and relative length is a function of data found in the literature. Murray's law, or Murray's principle is a formula for relating the radii of child segments to the radii of the parent segment of a lumen-based system. The branches classically refer to the branching of the circulatory system or the respiratory system, but have been shown to also hold true for the branching of xylem, the water transport system in plants.

Murray's analysis facilitates a determination of the segment radius that minimizes expenditure of energy by the organism. Larger vessels lower the energy expended in pumping fluid (e.g. blood, water, and the like) because the pressure drop in the vessels reduces with increasing diameter according to the Hagen-Poiseuille equation. Larger vessels increase the overall volume of fluid flowing through the system. In the event, that the system is a vascular system (i.e., one that transports blood), increasing the flow of blood means increasing metabolic support. Murray's law helps balance these factors.

For n child segments arising from a common parent segment, the formula is:

rₚ³=r_{c1}³+r_{c2}³+r_{c3}³+. . . r_{cn}³

where rₚ is the radius of the parent segment, and r_{c1}, r_{c2}, r_{c3}, and r_{cn} are the radii of the respective child branches. From Murray's law, it may be seen that larger diameter tubes are heavier because of both the tubing and the additional volume of enclosed fluid, but the pressure losses incurred are reduced and so the mass of the pumping system that is used can be lower. The (inner) tube diameter dᵢ which minimizes the total mass (tube+fluid+pump), is given by the following equation in laminar flow:

$${d}_{i}^{6} = \frac{1024 μ {Q}^{2}}{{π}^{2} K [ ρ TUBE ( {C}^{2} + C ) + ρ FLUID ]}$$

where Q is the volume flow rate, μ is the fluid viscosity, K is the power-to-weight ratio of the pump, ρTUBE is the density of the tubing material, C is a constant of proportionality linking vessel wall thickness with internal diameter and the ρFLUID is the density of the fluid.

For turbulent flow the equivalent relation is

$${d}_{i}^{7} = \frac{80 {Q}^{3} f ρ FLUID}{{π}^{3} K [ ρ TUBE ( {C}^{2} + C ) + ρ FLUID ]}$$

where f is the Darcy friction factor. The junction relations above can therefore be applied in the following form in turbulent flow:

rₚ^{7/3}=r_{c1}^{7/3}+r_{c2}^{7/3}+r_{c3}^{7/3}+ . . . +r_{cn}^{7/3}

The binary image of the network is bifurcated down to approximately segments having diameters of approximately 5.0 micrometers. A conductance is calculated for each virtual network (binarized image) by using serial/parallel relationships for the different virtual segments. The conductances for parallel segments are added while the reciprocal of conductances for serial segments are added to produce an equivalent conductance. This method is used on the entire vascular network to determine a total equivalent conductance. If a pressure is assigned to the source node and a pressure assigned to the capillary level, a series of linear equations can be used to determine the flow rate and pressure at every segment and junction. If the flow rates and pressures are known through the entire network, the velocity, Reynolds number, shear rates and shear stresses can be calculated using fundamental fluid equations.

Alternatively, once the flow rates and pressure at every segment and junction are known, one can design a new network, where fluids travel through the system with predetermined velocities, shear rates, shear stresses and Reynolds number. The knowledge of rates of fluid flow, shear stresses and shear rates, in a particular vascular system can also be used to determine whether a particular vascular system is diseased without necessarily imaging the system.

In addition, a knowledge of the rates of fluid flow, the Reynolds number, the conductances, the resistance to flow, the shear stresses and shear rates, and the like, in a particular vascular system can also be used to predict defects in vascular systems in the eyes, lungs, heart and the like.

The method and system discussed herein is embodied in the following non-limiting example.

### EXAMPLE

Quantitive evaluation of retinal blood flow parameters is essential for fast, reliable screening and diagnosis of diseases which manifest as hemodynamic or vascular changes in the retina. These diseases include diabetic retinopathy, glaucoma, AMD, as well as other ophthalmic and systemic conditions. For diabetic retinopathy in particular, it has been shown that early detection and treatment greatly reduces the chances of blindness.

Most screening for retinal diseases involves the acquisition and evaluation of a fundus photograph which usually displays the optic disc and the vasculature originating and terminating therefrom. Current practice requires a trained retina specialist to look for characteristic lesions such drusen, cotton wool spots or hemorrhages, and rate the severity of the disease on a numerical scale. Methods for automated detection of these lesions has been developed, which use machine learning to correlate the number and characteristics of lesions with severity categories. However, these methods do not analyze the geometry or the morphology of the retinal vasculature, which has been shown to provide many biomarkers for disease. Blood flow parameters, such as total retinal volumetric flow, have been investigated as an indicator of pathology. Current methods of volumetric measurement, however, are invasive and not entirely validated. Additionally, these measurements have yielded conflicting results when correlating with disease. This may be due to the autoregulatory functions of the vasculature in maintaining a healthy flow rate.

The volumetric flow rate is maintained through vasodilation and vasoconstriction, which affects the overall network vascular resistance. Retinal blood flow has been shown to remain essentially unchanged over a wide range of perfusion pressures. Therefore, the vascular resistance may be a more compelling factor in screening for disease.

The vascular resistance can be calculated by dividing the retinal perfusion pressure by the total volumetric flow, which is invasive and time-consuming by current methods. Another method of evaluating resistance involves analyzing the geometry and morphology of the vascular network. This example presents an automated approach to determining retinal vascular resistance from standard fundus imagery. The method analyzes the connectivity and shape of the retinal vessels to determine an overall network fluid resistance.

The images used in this study are hosted by the Department of Computer Science at the University of Erlangen-Nuremberg in Bavaria, Germany. Thirteen images were used, all of which were taken with a Canon CF-60UIDi camera with an EOS 20D attached. The photographs came from MD Kubena's Ophthalmology Clinic, Zlin, Czech Republic. All patients were European, were approximately 65 years of age, and were free of diabetic retinopathy or glaucoma.

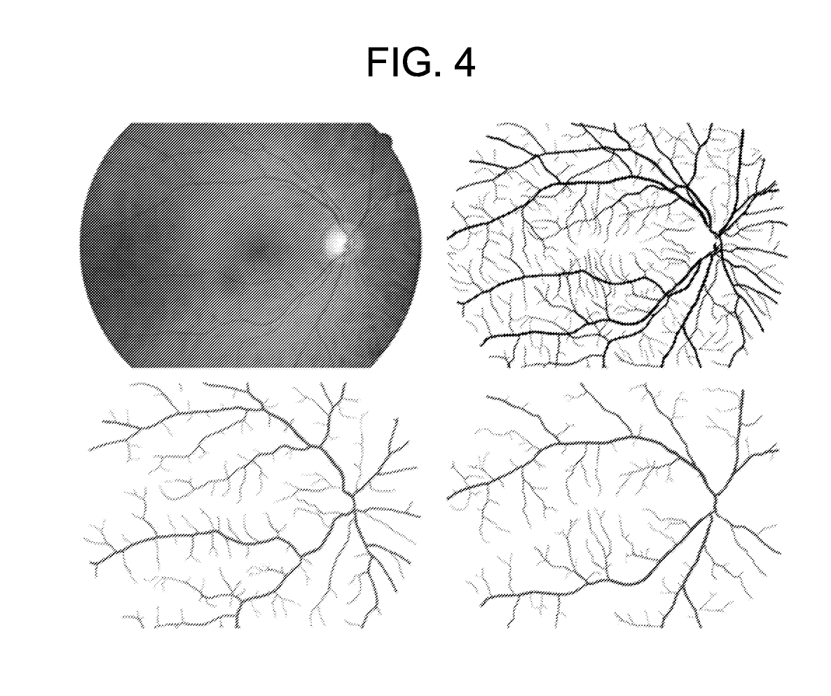

Each fundus photograph was fovea-centered, had a 60° field of view, and had a resolution of 3504×2336. For each color photograph, there was a binary segmentation of the vasculature. Each segmentation was performed manually by trained specialists for the purpose of testing automated segmentation algorithms. These “ground truth” images were used in this study to avoid errors associated with automated segmentation techniques. FIG. 4 depicts the original fundus image (top-left) was used along with its segmentation (top right) to define the arterial network (bottom left) and the venous network (bottom right).

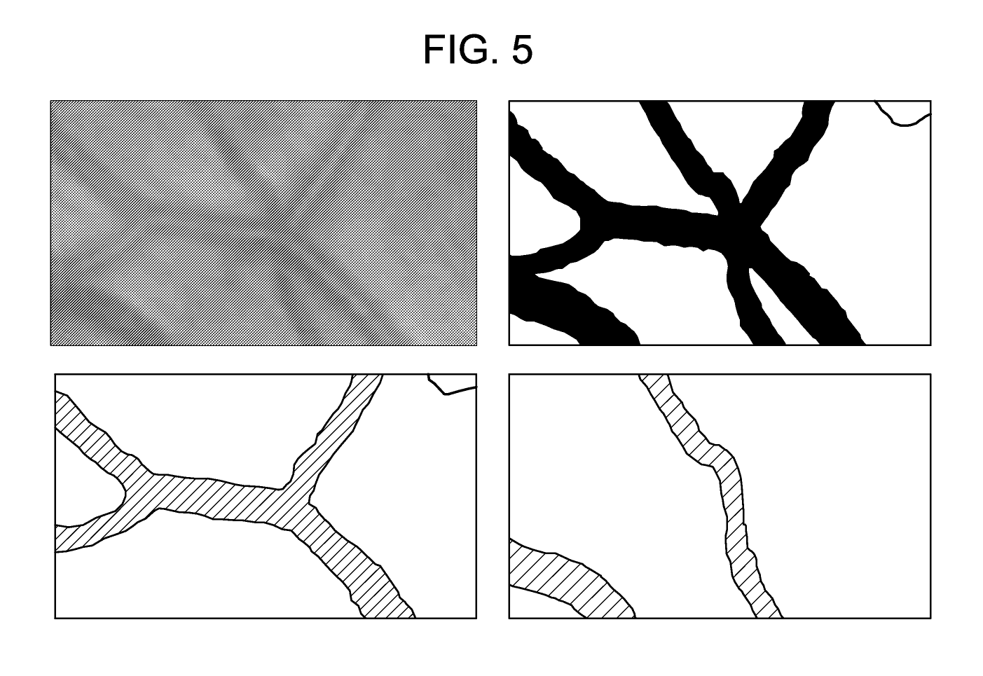

In order to create an arterial and venous vascular image from the original segmentation, vessels that were not of interest were manually removed. Arteries and veins were differentiated using vessel caliber, intensity values, relationships to neighboring vessels, and vessel tortuosity. For the arterial image, venous vessels were deleted from the original segmentation, while arterial vessels were deleted from the original to form a venous image. At arteriovenous crossover points, the unwanted vessel was removed to leave a smooth section of the vasculature of interest. FIG. 5 depicts a method of creating the arterial network. In order to create the arterial network (bottom left), the original fundus (top left) was inspected and the venous segments were removed from the segmented image (top right). In order to create the venous network (bottom right), the arterial segments were removed.

The arterial and venous vascular images were analyzed with minimal user interaction to determine the connectivity and relationships between various lengths of vasculature. This process required the definition of bifurcations and endpoints to separate the vasculature into segments and the nodes connecting them.

### Thinning and Cleaning

The vascular network image was thinned to a network of single pixel-wide vessels using a common thinning algorithm that greatly preserves the shape of the thinned object. This method sometimes results in small vessel artifacts protruding from actual vessels. These were deleted by removing all terminal segments (defined using a similar technique described later) which exhibited a length less than a particular threshold. Due to the limited field of view in the photograph, the vasculature sometimes exited and re-entered the image, leaving an unconnected vascular object. These objects were deleted, since there was no knowledge of the nature of the vasculature that connected it to the whole.

### Bifurcation and Endpoint Locations

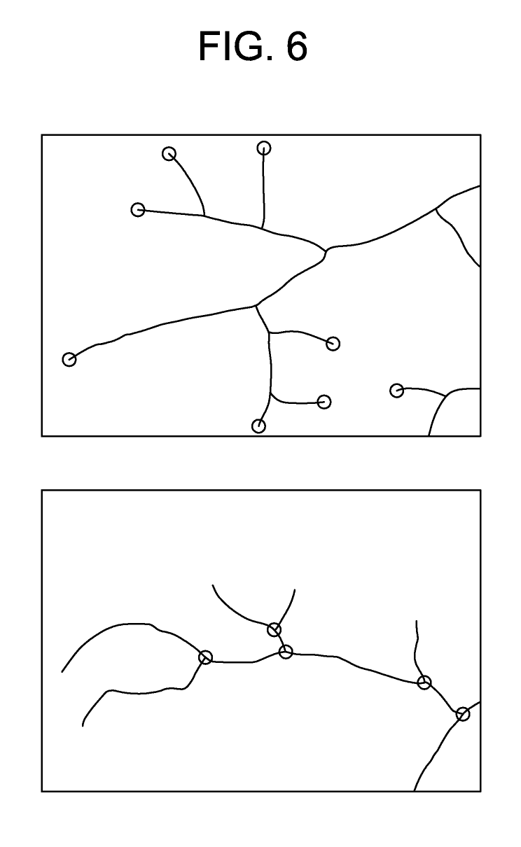

Throughout the vascular image there are many points of bifurcation, where one vessel (the parent) divides into two smaller vessels (the children). Anatomically, these bifurcations occur and continue to the capillary level, but within the segmented image the vessels appear to terminate. These are points at which the presence of vessel could no longer be evaluated from the original image when creating the segmentation. An endpoint can exist when either the resolution limit of the camera is reached or a vessel reaches the boundaries of the field of view. Bifurcation points and endpoints are of interest when defining the vascular network. FIG. 6 depicts how endpoints (top) were defined as points of observable termination while the bifurcations (bottom) were defined as points at which the network divides into two child segments.

A thinned network pixel's neighbors are defined as any vessel pixel existing within the 8-pixel perimeter around the network pixel of interest. The thinning algorithm previously used prevents the neighbors of any vessel pixel being neighbors to each other, which prevents 90° “elbows” within the thinned network. Endpoints were located by identifying vessel pixels that had only one neighbor, while bifurcation pixels were located by identifying vessel pixels at least with three neighbors. Rarely, a bifurcation occurs very close to one another which results in a cross-pattern or X-pattern in the thinned network. These are still regarded as bifurcation points.

### Definition of Segments and Nodes

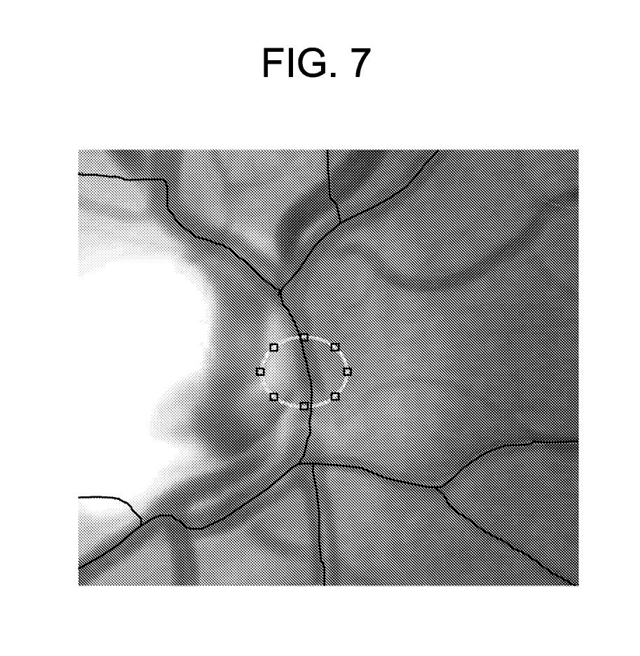

When defining the network, inclusive lengths of vasculature between bifurcations and endpoints were regarded as “segments”. Endpoints and bifurcation points are regarded as “nodes” which connect the segments. Additionally, an extra node regarded as the source node was defined by the user. This point marks the origin of all arterial flow and the destination of all venous flow. FIG. 7 depicts the thinned network (red) which was overlaid on the green layer of the original fundus image. The user then selected an origin point that defined the node of the central retinal artery or the central retinal vein.

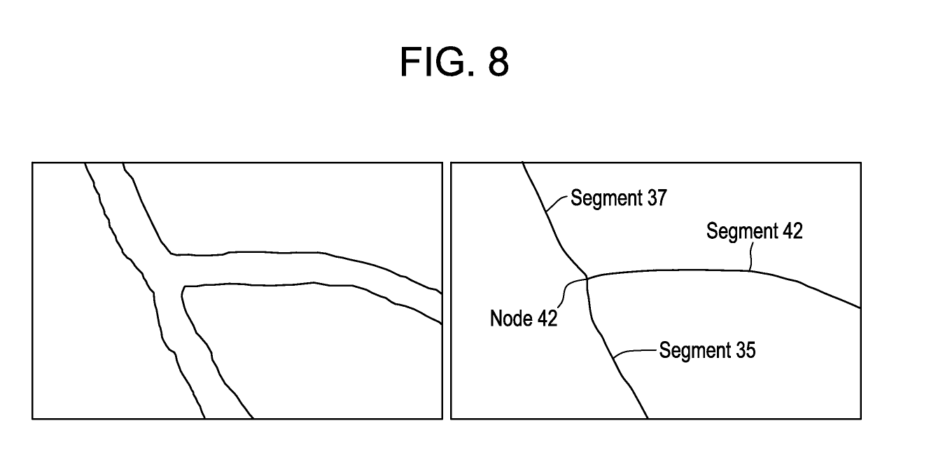

In order to define the segments, a walking algorithm was employed. Starting from a node pixel, a neighbor pixel was chosen and added to a vector of pixel indices comprising a segment. This vector was built further by adding each pixel's untouched neighbor until another node pixel is reached, at which point the segment was defined. This process was repeated until all possible segments were constructed and the relationships between nodes and segments were completely defined. FIG. 8 depicts that after being thinned, the network was defined in terms of segments, or lengths of pixels between bifurcations, or nodes, consisting of endpoints, bifurcation points, and the origin node.

### Segment Diameters and Lengths

For each segment, the diameter was defined by taking the mean of pixel-associated diameter measurements. These diameters were first estimated by doubling the distance from a thinned vessel pixel to the nearest non-vessel pixel in the segmented image. The widths of a vessel was first estimated by determining the distance from the thinned network to the nearest non-vessel pixel in the segmented image. Pixels that are more red define greater distances from non-vessel pixels.

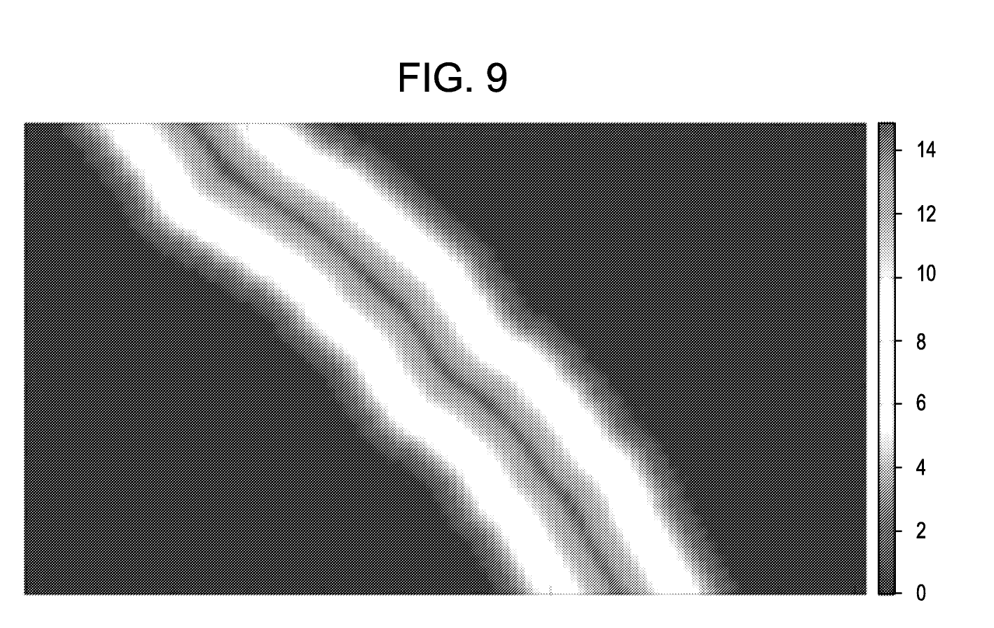

FIG. 9 shows that for each thinned pixel, a number of connected thinned pixels equal to 3/2 the estimated width was examined on either side. The direction of vessel growth was then determined by calculating the larger principal component direction from these pixels. The segmented vessel was then measured in the direction normal to the vessel growth direction to determine the segment diameter at that pixel. This measurement was made at approximately five points on the segment to yield a characteristic segment diameter. The segment length was calculated by summing the Euclidian center-to-center distances among neighboring pixels within the segment.

### Hagen-Poiseuille Flow

The Hagen-Poiseuille equation describes the change in pressure, ΔP, across a long, cylindrical pipe as a function of the pipe's length, L, and diameter, D, as well as the viscosity of the fluid, μ, and the volumetric flow rate through the pipe, Q.

$$Δ P = \frac{128 μ LQ}{π {D}^{4}}$$

The assumptions of Hagen-Pouiseuille flow are that the fluid is incompressible and Newtonian, and flow is laminar. Blood is an incompressible fluid and undergoes laminar flow in the retinal circulation, but its viscosity changes with shear rate, thus defining it as a non-Newtonian fluid. This issue is addressed by assigning an apparent blood viscosity to each segment. This equation for fluid flow is analogous to that of electrical circuits. Ohm's law is expressed in equation (1), while

$$\begin{matrix}V = R \cdot I & ( 1 ) \\ Δ P = ( \frac{128 μ LQ}{π {D}^{4}} ) \cdot Q & ( 2 ) \\ {R}_{f} = \frac{128 μ L}{π {D}^{4}} & ( 3 )\end{matrix}$$

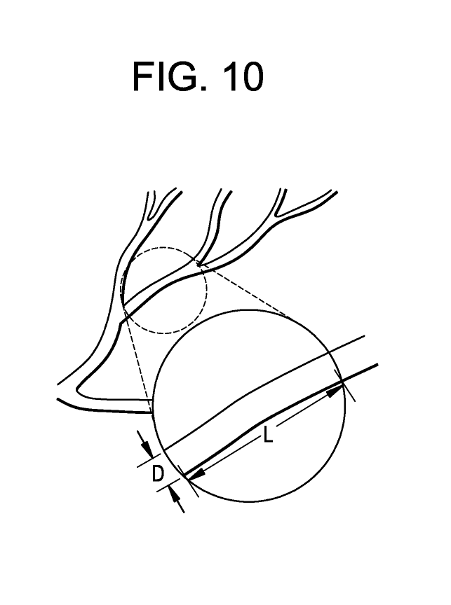

equation (2) is rewritten in equation (3). By comparing the two equations, it can be seen that the pressure and flow rate are analogous to voltage and current, respectively. Thus, the fluid resistance, R_{f}, can be defined as in equation (3). FIG. 10 depicts that the resistance of a segment was defined by its geometry alone. The diameter defined the viscosity of the blood flowing through the segment, which was then used with the length and diameter to calculate the fluid resistance of the segment.

If the length and diameter of the vessel are known, and the effective viscosity of the blood passing through the segment are known, a fluid resistance can be assigned to the segment.

### Segment Viscosity

The viscosity of blood has been shown to depend highly on the diameter of the vessel through which it passes and the hematocrit level of the blood itself. The modeling viscosity as a function of these parameters can be seen in equations 4-7.

$$\begin{matrix}\frac{{μ}_{vivo}}{μ} = [ 1 + ( \frac{{μ}_{0.45}}{μ} - 1 ) \frac{{( 1 - {H}_{D} )}^{C} - 1}{{( 1 - 0.45 )}^{C} - 1} {D}^{′} ] ( {D}^{′} ) & ( 4 ) \\ \frac{{μ}_{0.45}}{μ} = 6 {e}^{- 0.085 D} + 3.2 - 2.44 {e}^{- 0.06 {D}^{0.645}} & ( 5 ) \\ {D}^{′} = {( \frac{D}{D - 1.1} )}^{2} & ( 6 ) \\ C = ( 0.8 + {e}^{- 0.075 D} ) ( \frac{1}{1 + {10}^{- 11} {D}^{12}} - 1 ) + \frac{1}{1 + {10}^{- 11} {D}^{12}} & ( 7 )\end{matrix}$$

The apparent viscosity, apparent viscosity at a hematocrit level of 0.45, plasma viscosity, and discharge hematocrit level are represented by μvivo, μ0.45, μ, and H_{D}, respectively. An apparent blood viscosity for each segment in the network using this model assuming a discharge hematocrit level of 0.45 is calculated.

### Equivalent Conductance

With the diameter, length and viscosity of each segment determined, a fluid resistance for each segment from equations (8) and (9) below was calculated. Just as an equivalent resistance can be calculated among various electrical resistors, it is possible to calculate an equivalent fluid resistance among various flow channels. The equivalent fluid resistances for two segments in series (the node shared between the two segments is not shared by any other segments) and in parallel (two segments sharing the same set of nodes) are shown in equations (8) and (9).

$$\begin{matrix}{R}_{f , series} = {R}_{f , 1} + {R}_{f , 2} & ( 8 ) \\ {R}_{f , parallel} = {( \frac{1}{{R}_{f , 1}} + \frac{1}{{R}_{f , 2}} )}^{- 1} & ( 9 )\end{matrix}$$

Because the network consists only of bifurcations and non-connected endpoints, it is impossible to begin finding equivalent fluid resistances without first finding a way to create serial or parallel conditions.

### Virtual Conductance at Endpoints

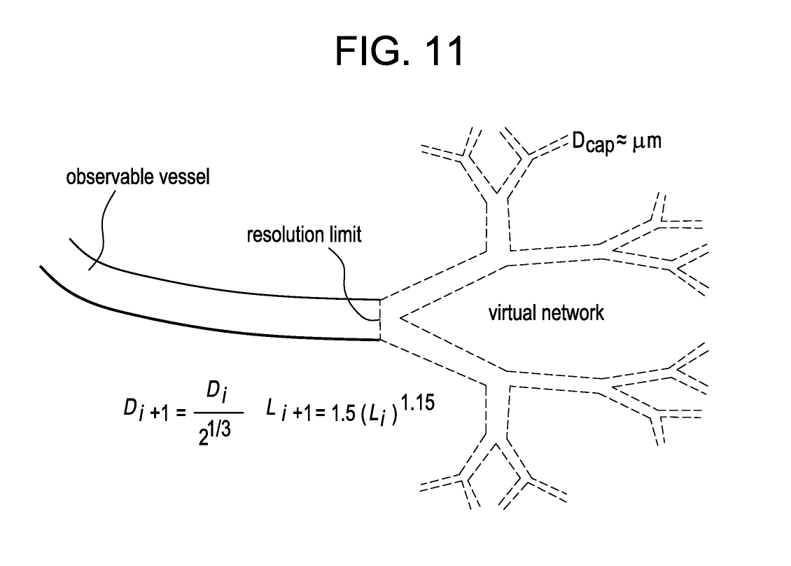

The observable vascular network is analogous to an incomplete circuit diagram, or more specifically a circuit diagram with unknown behavior after certain points. Each endpoint in the segmented image represents a point beyond which the geometry and morphology of the network are unknown. When an endpoint was encountered, a series of bifurcations exhibiting a predetermined geometric nature was appended to connect the segment to the capillary bed as shown in the FIG. 11. An endpoint with a greater diameter had a greater number of bifurcations stemming therefrom.

In order to address this issue, each endpoint was appended with a “virtual network” consisting of symmetric dichotomous bifurcations to the capillary level. The geometry of the bifurcating vessels was based on theoretical and empirical models seen in equations (1) through (9).

D_{child}=(½)^{1/3}Dₚₐᵣₑₙₜ (10)

L_{child}=1.7(Dₚₐᵣₑₙₜ)^{1.15} (11)

where D_{child} is the diameter of a child segment; Dₚₐᵣₑₙₜ is the diameter of a parent segment and L_{child} is the length of the child segment.

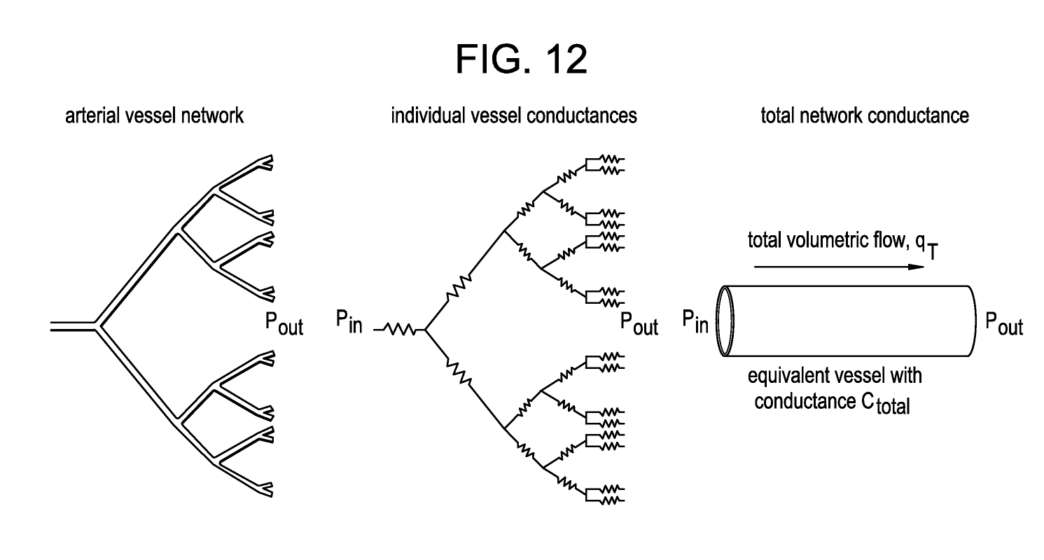

The equivalent resistance of the virtual network was then calculated using equations (8) and (9), treating the capillary bed as a single node, similar to a ground voltage in a circuit network. These resistances were then appended to the endpoints to define a complete network up to the capillary bed. The equivalent resistance was then calculated for the entire arterial or venous network. FIG. 12 shows the model and the calculation of the fluid resistance which is conducted in a manner very similar to finding the equivalent resistance of a circuit network. The analogous properties are voltage to pressure, volumetric flow to current, and electrical resistance to fluid resistance.

The equivalent fluid resistance was calculated for 13 healthy arterial network sand 13 healthy venous networks. The means of the arterial and venous network resistance with the virtual network appended, in mmHg-min/μL, were 0.318+/−0.101 and

0.196+/−0.037, respectively. The mean arterial and venous resistances without the virtual networks were 0.210+/−0.079 and 0.118+/−0.027, respectively. The network resistance without the virtual network was calculated by assuming a constant pressure at all observable endpoints.

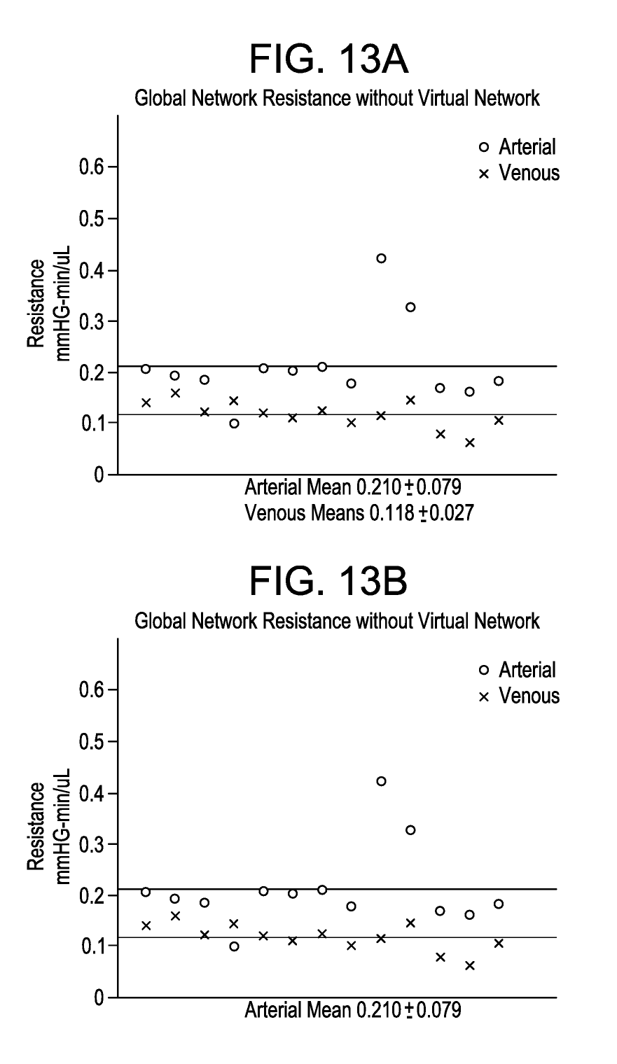

FIG. 13A shows that the fluid resistance for arteries and veins along a line displaying the means are shown for networks without the virtual networks attached. FIG. 13B shows that the fluid resistance for arteries and veins along a line displaying the means are shown for networks with the virtual networks attached.

The virtual networks increased the mean resistance by approximately 51% in the arterial networks and 66% in the venous networks. This was expected, as the addition of virtual vessels was done in a serial manner and increases the fluid resistance according to equation (8).

Additionally, the ratio of the standard deviation of the resistances to the mean of the resistances decreased with the appendage of the virtual network. Because the virtual network was generated in the same manner for each eye, and the resolution and field of view were similar in each image, a greater level of uniformity was introduced into the data. As the resolution or field of view is increased, the virtual network should become less of an influence on the calculation of the fluid resistance.

The arterial networks consistently had a higher resistance than its venous counterpart, which, would imply a steeper pressure gradient across the arterial vasculature than the venous vasculature. However, mean ratio of arterial to venous resistance, 1.64, is lower than the generally reported values in cat mesenteries, which usually range from 3.0 to 4.0. This may be due to differences in branching patterns beyond the observable endpoints in arteries and veins, or it could be attributed to anatomical differences in the retinal vasculature.

Under the assumption that the arterial, capillary and venous resistances act in series, the total retinal fluid resistance, from the central retinal artery to the central retinal vein, can be calculated as

Rₜₒₜₐₗ=Rₐ+R_{cap}+Rᵥ (12)

where Rₐ is the resistance across the arterial network, R_{cap} is the resistance across the capillary bed and Rᵥ is the resistance across the venous network. Reported values of retinal vascular resistance, calculated by dividing the retinal perfusion pressure by the total volumetric flow rate, vary from 3.0 to 6.0 mmHg-min/μL. The combined arterial and venous resistances averaged 0.51 mmHg-min/μL, which would require a capillary resistance

comprising over 80% of the total resistance to correlate with physical findings. Because of this discrepancy in values, the resistances reported should be considered on a comparative basis rather than in an absolute sense.

A new method of analyzing the vasculature in fundus imagery to determine the arterial and venous fluid resistance is presented. This metric is independent of invasive measurements of volumetric blood flow and estimated calculations of perfusion pressure in the retina.

The fluid resistance is based purely on the observable geometry and morphology of the retinal vasculature, providing further insight into the mechanisms of autoregulation that function during abnormal conditions of disease. This contrasts with the previous calculations of retinal perfusion pressure based on physical measurements. Initial results show a greater arterial resistance, which conforms to previous findings. While the absolute values of the fluid resistance do not correlate with previous calculations, the results may still be used on a comparative basis, as shown in the arterio-venous differences. By utilizing this tool, it may be possible to screen for diseases that manifest in changes to retinal vascular resistance.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, singular forms like “a,” or “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The term and/or is used herein to mean both “and” as well as “or”. For example, “A and/or B” is construed to mean A, B or A and B.

The transition term “comprising” is inclusive of the transition terms “consisting essentially of” and “consisting of” and can be interchanged for “comprising”.

While this disclosure describes exemplary embodiments, it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the essential scope thereof. Therefore, it is intended that this disclosure not be limited to the particular embodiment disclosed as the best mode contemplated for carrying out this disclosure.

What is claimed is:

1. A method for designing an organ for use in a body of a living being comprising:
identifying a fluid transport demand of an organ; where the fluid transport demand is the amount of fluid used by the organ to sustain itself and to sustain utility in other organs around it; and where the organ comprises a flow system comprising a network of vessels;
determining a spatial density of zones of need in the organ based on a density of normal healthy tissues in the organ;
identifying a nature of the flow system; and
using constructal principle analysis to generate a design of the organ.

2. The method of claim 1, where the nature of the flow system is a point source to area system, an area to point source system, or a combination thereof.

3. The method of claim 1, where the constructal principle analysis involves considering an efficiency of the flow system, boundary conditions on the flow system, energy minimization analysis of the flow system, guiding forces of the flow system, design constraints on the flow system, minimization of losses in the flow system, or a combination thereof.

4. The method of claim 1, where the constructal principle analysis provides an optimization of network yields branch point location, end to end distance of a vascular network present in the organ, the radius of gyration of the vascular network, junction angles of branches of the vascular network, vessel diameters, vessel lengths, vessel tortuosities, junction exponents, asymmetry ratios, area ratios, parent-child angle changes, parent-child vessel diameter ratios-child-child diameter ratios, overall links, volume of observable vasculature, metrics as a function of vessel generations, metrics as a function of location, or a combination thereof.

5. The method of claim 1, further comprising generating a design layout of the organ from the constructal principle analysis.

6. The method of claim 1, further comprising manufacturing the organ.

7. The method of claim 6, where the manufacturing comprises molding the organ.

8. The method of claim 6, where the manufacturing comprises 3D-printing.

9. The method of claim 7, where the molding comprises injection molding or compression molding.

10. An organ manufactured by a method comprising:
identifying a fluid transport demand of an organ; where the fluid transport demand is the amount of fluid used by the organ to sustain itself and to sustain utility in other organs around it; and where the organ comprises a flow system comprising a network of vessels;
determining a spatial density of zones of need in the organ based on a density of normal healthy tissues in the organ;
identifying a nature of the flow system; and
using constructal principle analysis to generate a design of the organ.

11. The organ of claim 10, where the organ comprises a polymer.

12. The organ of claim 11, where the polymer is a biopolymer; and where the biopolymer comprises polynucleotides, polypeptides, polysaccharides, or a combination comprising at least one of the foregoing biopolymer.

13. The organ of claim 11, where the polymer is biodegradable.

14. The organ of claim 13, where the biodegradable polymer is polylactic-glycolic acid, poly-caprolactone, copolymers of polylactic-glycolic acid and poly-caprolactone, polyhydroxy-butyrate-valerate, polyorthoester, polyethylene oxide-butylene terephthalate, poly-D,L-lactic acid-p-dioxanone-polyethylene glycol block copolymer or a combination comprising at least one of the foregoing biodegradable polymers.

15. The organ of claim 11, where the polymer is a thermoplastic polymer; where the thermoplastic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfonamide, a polyurea, a polyphosphazene, a polysilazane, a polytetrafluoroethylene, a polysiloxane, or a combination comprising at least one of the foregoing thermoplastic polymers.

16. The organ of claim 11, where the polymer is a thermosetting polymer; where the thermosetting polymer is an epoxy polymer, an unsaturated polyester polymers, a polyimide polymer, a bismaleimide polymer, a bismaleimide triazine polymer, a cyanate ester polymer, a vinyl polymer, a benzoxazine polymer, a benzocyclobutene polymer, an acrylic, an alkyd, a phenol-formaldehyde polymer, a novolac, a resole, a melamine-formaldehyde polymer, an urea-formaldehyde polymer, a hydroxymethylfuran, an isocyanate, a diallyl phthalate, a triallyl cyanurate, a triallyl isocyanurate, an unsaturated polyesterimide, or a combination comprising at least one of the foregoing thermosetting polymers.

17. The organ of claim 10, where the organ is coated with a biocompatible polymer, polytetrafluoroethylene, polysiloxane, or a combination thereof.
